(19) United States
(12) Patent Application Publication
(10) Pub. No.: US 2015/0091815 A1
(43) Pub. Date: Apr. 2, 2015

(54) Method and Apparatus to Support Visually Impaired Users of Touchscreen Based User Interfaces

(71) Applicant: Avaya Inc., Basking Ridge, NJ (US)

(72) Inventor: Paul Roller Michaelis, Louisville, CO (US)

(73) Assignee: Avaya Inc., Basking Ridge, NJ (US)

(21) Appl. No.: 14/043,657

(22) Filed: Oct. 1, 2013

(51) Int. Cl. G06F 3/0354; G06F 3/041

(52) U.S. Cl. CPC G06F 3/03545; G06F 3/041
USPC 345/173

(57) ABSTRACT

A system and method for providing an assistive adjunct for blind and low vision users is described. Specifically, the contact between a telescoping stylus and a touchscreen may be detected, where the stylus is capable of providing two or more footprints. When the stylus is touched lightly to a touchscreen, only the tip of the innermost tube makes contact with the touchscreen, thereby triggering a first response. If the user presses down on the stylus to cause the innermost tube to collapse into a middle tube until the center tube and the middle tube both touch the touchscreen, this additional contact is detected by the device thereby triggering a second response. Additional pressure on the stylus can cause all three tubes to make contact with the touchscreen, thereby causing yet another detectable contact and triggering a third response.

### FIELD OF THE DISCLOSURE

An exemplary embodiment is generally directed toward an assistive adjunct that provides discrete and/or continuous adjustments for use with a touchscreen based user input system.

### BACKGROUND

Several third-party assistive software adjuncts are available for blind and low-vision users of Windows® based personal computers. As one example, text-to-speech adjuncts exist that read information to blind users via one or more audio speakers. For low-vision users, some products provide a mouse-controlled “magnifying glass” that the users may position over any portion of the screen that needs to be enlarged. An important point is that, when these assistive adjuncts are being used, all functionality of the software being accessed in conjunction with the adjuncts remains exactly as it would be if the assistive adjuncts were not being used. The third-party assistive software adjuncts developed for blind users of the Windows® operating systems do not work on iOS® devices or on Android® devices.

In order to operate Android® and iOS® based user interfaces, blind users commonly rely on products, separately or together, having text-to-speech converters and touch based assistive adjuncts. For example, if an element presented visually has an underlying text tag, when enabled, an application will “speak” the contents of the tag when that element receives focus—e.g., when that element is touched or selected via keyboard navigation. Additionally, when enabled, touch based assistive adjuncts cause significant changes to the user interface. For example, the user may put his or her finger onto a touchscreen and slide it around, listening for the application to speak the desired action. When the desired action is heard, the user may tap anywhere on the touchscreen to cause that action to be executed. However, although these assistive software adjuncts are available, at least two problems exist. The first problem concerns a device in which a text-to-speech and/or touch based assistive adjuncts have been enabled is likely to be inoperable by a person unfamiliar with this interface style, who may instead be expecting a standard user interface, such as the standard iOS®/Android® look-and-feel. For example, the standard “touch to activate” does not work. Instead, the function must be touched, followed by tapping on the screen to activate. Similarly, scrolling through a list by sliding a single finger may not be supported; instead, two fingers must be used. And so on.

The second problem, and perhaps of greater concern, is that a blind user cannot optimally use a touchscreen device that does not have text-to-speech and/or touch based assistive adjunct options enabled. This is a significant issue if the device is used by more than one person, such as the speakerphone in a conference room for example.

Additionally, low-vision users for whom the blind-oriented assistive adjuncts may not be optimal solutions, have access to a zoom function that is controlled by putting two fingers onto the screen and then spreading them apart or moving them closer together. Low-vision users also have the ability to specify font sizes. A problem with these functions is that, when used to expand a component of the screen, other objects tend to be pushed off the screen. Accordingly, there is room for improvement in existing assistive adjuncts for blind and low-vision users.

### SUMMARY

It is with respect to the above issues and other problems that the embodiments presented herein were contemplated. This disclosure provides, among other things, the ability to provide support for blind users immediately on all devices without having to change user preference settings and while preserving the standard look-and-feel for users who do not require special accommodations. Additionally, for low vision users, the ability to magnify a specific component of a display without causing other components to be pushed off the screen is provided.

In one embodiment consistent with the present disclosure, the embodiment relies on a special-purpose telescoping stylus, used in conjunction with an electronic device having a touchscreen that provides different modes of behavior and different responses depending on the electronic device's identification of what is touching the touchscreen. For example, users not requiring support would continue to use their fingers to touch the touchscreen, as they do today. Upon detection of a finger touch, the electronic device may behave as it does ordinarily. By contrast, rather than touching the touchscreen with their fingers, users having visual impairments would touch the touchscreen with a special purpose stylus. The tip of the stylus would be different, in a way detectable by the electronic device, depending on whether the user is blind (therefore requiring voice output from the device) or has low vision (therefore requiring selective screen magnification). That is, as one example, one of three operational modes may be entered based on whether the item contacting the touchscreen is a finger, whether the item contacting the touchscreen is a stylus identified as a low-vision stylus, or whether the item contacting the touchscreen is a stylus identified as a stylus for use by users who are blind.

Embodiments of the present invention may provide a stylus that comprises spring-loaded telescoping concentric tubes. The stylus can be envisioned as looking a little like a small extended radio antenna, except that the diameter of the stylus tip would not exceed the diameter of the innermost tube. In some embodiments, and as one example illustration as to how the stylus may work, the stylus may have three tubes: when the stylus is touched lightly to a specific actionable spot on a touchscreen, only the tip of the innermost tube makes contact with the screen, thereby triggering Response #1. If the user does not move the stylus from that spot, but presses down on it to cause the innermost tube to collapse into the middle tube until the center tube and the middle tube both touch the screen, this additional contact is detected by the electronic device thereby triggering Response #2. Additional pressure on the stylus may cause all three tubes to make contact with the screen, thereby causing yet another detectable contact and triggering Response #3. When pressure is removed from the stylus, the concentric tubes spring back to their original positions.

As one example illustrating how the stylus may be used by a user who is blind, touching an item with the stylus tip may trigger the electronic device to provide a voiced description of the item being touched. Pushing the barrel of the stylus down, causing the innermost tube to collapse into the middle tube until the center tube and the middle tube both touch the touchscreen, may cause the touched item to be activated. Alternatively, or in addition, pushing the barrel of the stylus down, causing the innermost tube to collapse into the middle tube until the center tube and the middle tube both touch the touchscreen, may cause the touched item to be “readied for activation” and then activated when the stylus is lifted from that spot. Pushing the barrel down even further, such that all three concentric tubes are touching, may cancel the operation.

As one example illustrating how the stylus may be used by a low vision user, touching an item with the stylus tip may trigger the electronic device to selectively magnify that item. Pushing the barrel of the stylus down, causing the innermost tube to collapse into the middle tube until the center tube and the middle tube both touch the touchscreen, may cause the touched item to be activated. Alternatively, or in addition, pushing the barrel of the stylus down, causing the innermost tube to collapse into the middle tube until the center tube and the middle tube both touch the touchscreen, may cause the touched item to be “readied for activation” and then activated when the stylus is lifted from that spot. Pushing the barrel down even further, such that all three concentric tubes are touching, may cancel the operation.

In some embodiments consistent with the present disclosure, a stylus that is optimized for non-blind users and/or users not having low vision may also be provided, identifiable by the electronic device based on the unique shape of the tip of the stylus and/or an encoded pattern thereon. Illustratively, assuming a four-barrel style stylus, Response #1 may be the equivalent of a mouse-over event, Response #2 may be the equivalent of a mouse left-click event, Response #3 may be the equivalent of a right-click event, and Response #4 may be the equivalent of a double-click event. The above behaviors are illustrative only and it is contemplated that other behaviors may be activated based on one or more responses. However, different behaviors are elicited depending on the stylus tip and on how many of the concentric stylus tubes contact the screen, and, in some embodiments, the behavior elicited by finger touches may be unchanged from the standard look-and-feel of the device.

Alternatively, or in addition, the stylus may be optimized to provide control using a stylus that deforms in a smooth predictable manner. For example, similar to the way one might use a potentiometer on an old-style device for functions such as volume or brightness control, as a user applies pressure to the stylus and the stylus deforms, a response may be invoked based on a detectable amount of deformation of the stylus. For instance, the contact between the stylus and the touchscreen may be measured and a response, proportional to the measured size of the stylus, may be invoked. As one example, as the user applies additional pressure to the stylus, the brightness of touchscreen and/or the magnification level of a touchscreen may be increased. In such instances, the stylus may provide smooth user-controlled responses in response to a continuous, or smooth, deformation of the stylus.

In one embodiment, a method is provided, the method comprising detecting, at an input receiving device associated with an electronic device, an input; determining whether the detected input corresponds to one or more stored footprints of a stylus; determining at least one response associated with the corresponding one or more stored footprints of the stylus, wherein the stylus is capable of creating a plurality of discrete footprints depending on a pressure applied to the stylus; and invoking the at least one response at the device.

In yet another embodiment, another method is provided, the method comprising detecting, at a touchscreen associated with an electronic device, contact between a stylus tip and the touchscreen, wherein the stylus tip deforms in a continuous manner depending on a pressure applied to the stylus; measuring at least one attribute of the detected contact; determining a response based on the measurement of the at least one attribute of the detected contact; and invoking the response at the device.

Additionally, an electronic device is provided, the electronic device comprising an input receiving device; a contact detector that detects contact between a stylus and the input receiving device, the contact detector configured to determine whether the detected contact corresponds to one or more stored footprints of the stylus; and a controller that determines at least one response associated with the corresponding one or more stored footprints of the stylus and invokes the at least one response.

Further aspects of the embodiments relate to a stylus that includes Rule 508 Compliance (Section 508 of the Workforce Rehabilitation Act Amendments of 1998—US Code of Federal Regulations, 36 CFR Part 1194).

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

Exemplary embodiments of the present disclosure are described in conjunction with the appended figures where:

FIG. 1A-1C depict a system diagram of a touchscreen device and stylus in accordance with an exemplary embodiment of the present disclosure;

FIGS. 2A-2E depict a stylus and additional details pertaining to the stylus tip in accordance with an exemplary embodiment of the present disclosure;

FIG. 3A-3D depict a stylus and additional details pertaining to the stylus tip in accordance with an exemplary embodiment of the present disclosure;

FIG. 4A-4C depict a stylus and additional details pertaining to the stylus tip in accordance with an exemplary embodiment of the present disclosure;

FIG. 5A-5D depict a stylus and additional details pertaining to the stylus tip in accordance with an exemplary embodiment of the present disclosure;

FIG. 6A-6C depict a stylus and additional details pertaining to the stylus tip in accordance with an exemplary embodiment of the present disclosure;

FIG. 7A-7C depict a stylus and additional details pertaining to the stylus tip in accordance with an exemplary embodiment of the present disclosure;

FIG. 8A-8C depict an embodiment wherein the stylus may be a finger in accordance with an exemplary embodiment of the present disclosure;

FIG. 9 is a block diagram of a device having a touchscreen in accordance with an exemplary embodiment of the present disclosure;

FIG. 10 is a flow diagram depicting a method associated with a touchscreen device in accordance with an exemplary embodiment of the present disclosure;

FIG. 11 is a second flow diagram depicting a method associated with a touchscreen device in accordance with an exemplary embodiment of the present disclosure;

FIG. 12 is a third flow diagram depicting a method associated with a touchscreen device in accordance with an exemplary embodiment of the present disclosure; and

FIG. 13 is a fourth flow diagram depicting a method associated with a touchscreen device in accordance with an exemplary embodiment of the present disclosure;

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Furthermore, while embodiments of the present disclosure will be described in connection with touchscreen devices, it should be appreciated that embodiments of the present disclosure are not so limited. In particular, embodiments of the present disclosure can be applied to devices utilizing a contact between at least one surface and an input device as a manner of user input. For example, embodiments of the present disclosure may be applied equally to touchpads, or touch sensitive surfaces not having the ability to display an output. Those skilled in the art will recognize that the disclosed techniques may be used in any application in which it is desirable to provide enhanced input capabilities.

The exemplary systems and methods will also be described in relation to software (such as drivers), modules, and associated hardware. However, to avoid unnecessarily obscuring the present embodiments, the following description omits well-known structures, components and devices that may be shown in block diagram form, are well known, or are otherwise summarized.

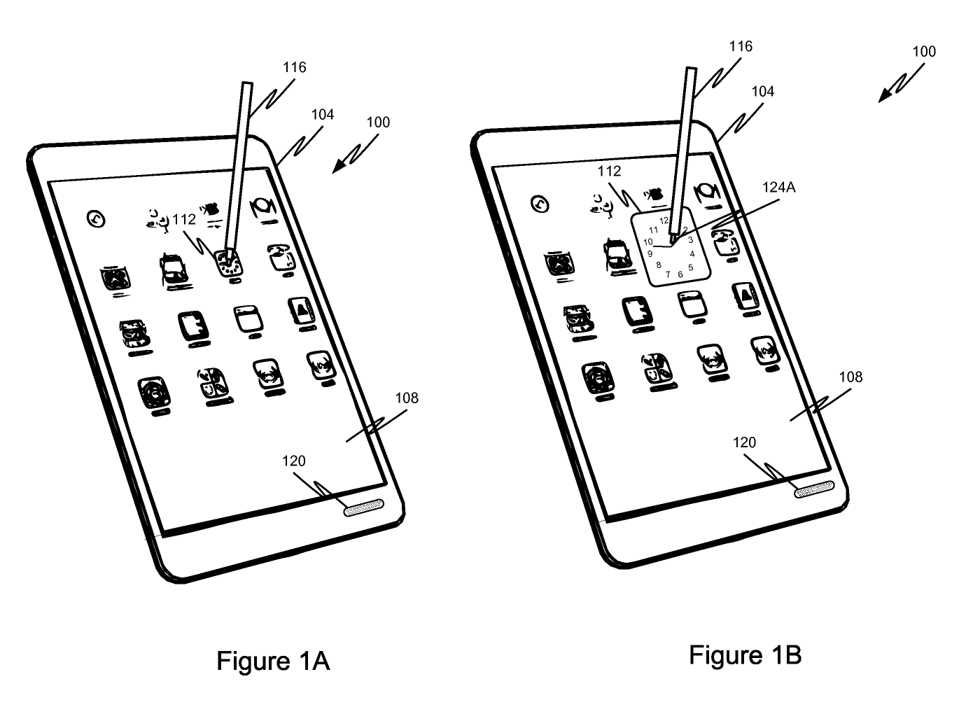

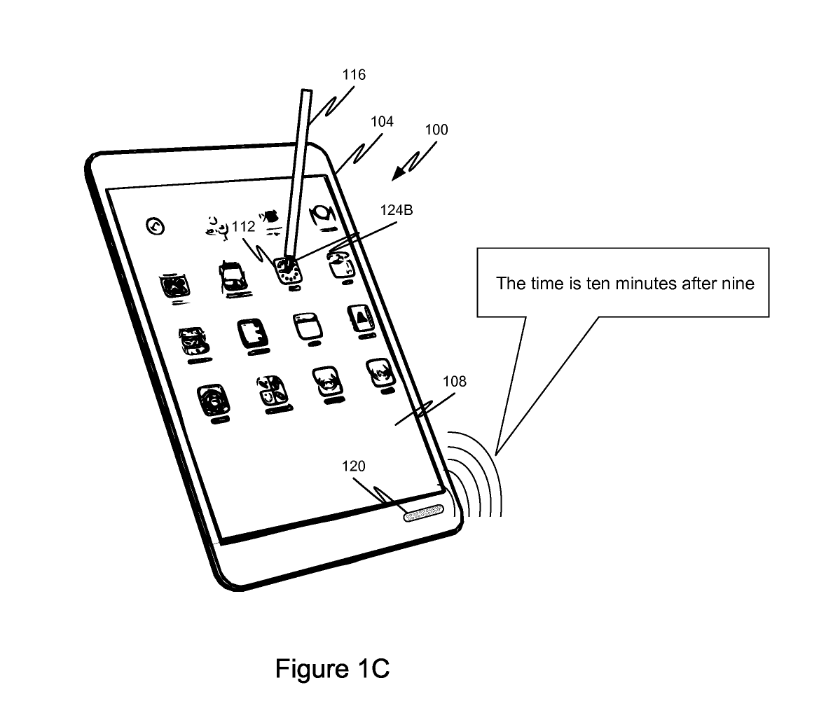

FIG. 1A depicts an illustrative embodiment of a touchscreen based user input system 100 in accordance with at least some embodiments of the present disclosure. The touchscreen based user input system 100 includes an electronic device 104 having a touchscreen 108, one or more icons 112, and a stylus 116. The electronic device 104 may be any device capable of receiving an input via a touchscreen 108. For example, the electronic device 104 may be a tablet, a pda, a smartphone, an e-reader, or the like.

The touchscreen 108 may be any electronic visual display that can detect the presence and location of a touch within a display area. The touchscreen 108 generally allows for a user to interact directly with what is being displayed via direct manipulation, rather than indirectly using a mouse, keyboard, or other form of input. The term “touchscreen” generally refers to a touch or contact to the display of the device by a finger, fingers, hand. The touchscreen 108 may also sense and identify other forms of passive objects, such as a stylus 116. Moreover, a touchscreen 108 may detect one or more enhanced functionalities, such as multi-touch input and/or other capabilities utilizing various combinations of gestures, to invoke a particular response.

There are a number of technologies that support various touchscreens; such technologies, may include but are not limited to resistive technologies, surface acoustic wave technologies, capacitive technologies, surface capacitance technologies, projected capacitance technologies, strain gauge technologies, optical imaging technologies, dispersive signal technologies, acoustic pulse recognition technologies, and coded LCD (bi-directional screen) technologies. Such technologies may allow a user to interact with the touchscreen 108 such that a contact with the touchscreen 108 is detected. Contact may include actual contact and/or perceived contact. Actual contact may be detected when contact is made between the touchscreen 108 and an object touching touchscreen 108. Perceived contact may occur in instances where no actual contact is made between the touchscreen 108 and the object; however, the distance between the object and the touchscreen 108 is such that contact is perceived. Contact with the touchscreen 108 may provide a location (actual or relative) and/or a response, or action, to be invoked.

For instance, a user contacting touchscreen 108 directly above an icon 112 may cause an application associated with the icon 112 to be launched or otherwise executed. In some instances, a double-tap of the icon 112 may be required to cause the application associated with the icon 112 to be launched or otherwise activated. Such actions may be customized and/or may depend on one or more touchscreen drivers. For example, various touchscreen drivers may allow one or more fingers to facilitate functionality corresponding to one or more common mouse operations. For instance, a user may tap the icon 112 a certain number times within a specified duration of time to cause one response, apply continuous contact for a specified duration of time to the icon 112 to cause another response, and/or touch a specific location on icon 112 to cause a third response. However, it is important to note that time delayed responses, such as requiring contact with an icon 112 for specified period of time to cause the application associated with icon 112 to launch, are not Section 508 compliant (Section 508 of the Workforce Rehabilitation Act Amendments of 1998—US Code of Federal Regulations, 36 CFR Part 1194).

In some embodiments consistent and with the present disclosure, a stylus 116 is provided that provides support for users using a touchscreen 108 of an electronic device 104 who may be blind and/or have low vision. As will be described below, a stylus 116 may be provided having one or more collapsible members, or tubes, where as each collapsible member makes contact with the touchscreen 108, a different action or response is initiated and/or invoked. As illustrated in FIG. 1A, a stylus 116 may contact a touchscreen 108 directly above icon 112 such that a first collapsible member, or tube, is in contact with the touchscreen 108. As a user applies pressure to the stylus 116, one or more collapsible members of the stylus tip 124 may contact the touchscreen 108 above the icon 112 eliciting a determined response. For example, FIG. 1B illustrates an example of two collapsible members of stylus tip 124A contacting a touchscreen 108 above icon 112; as a response, icon 112 may be magnified and/or enlarged. As another example, FIG. 1C illustrates an example of two collapsible members of stylus tip 124B contacting a touchscreen 108 above icon 112; as a response, the electronic device 104 may cause an appropriate audio response, such as “the time is ten minutes after nine” to be output from a speaker 120. Additionally, the stylus 116 depicted in 1B and the stylus 116 depicted in 1C have different tips 120A, 120B, allowing the device to know whether “low vision support mode” (1B) or “blind support mode” (1C) should be enabled.

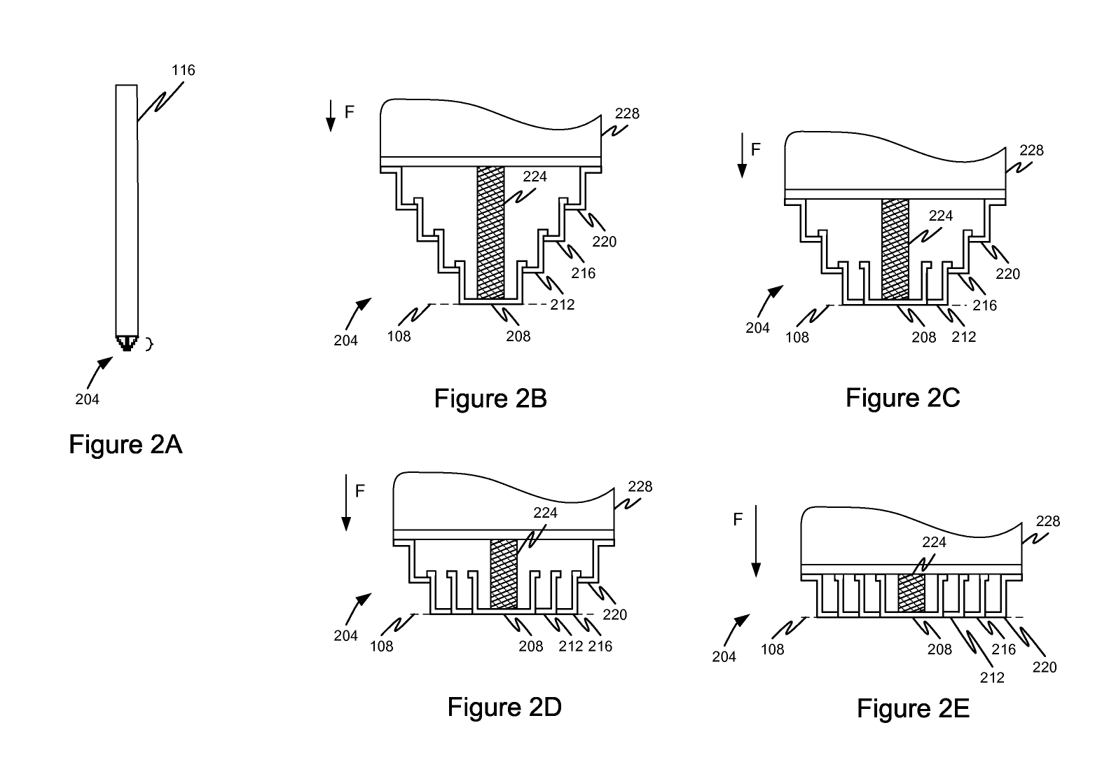

In accordance with some embodiments of the present disclosure, FIGS. 2B-2E provide additional details of an example stylus 116 depicted in FIG. 2A. The stylus 116 may include a stylus tip 204 provided at one end of a stylus body 228 belonging to the stylus 116. Although not illustrated, it is contemplated that stylus 116 may further include a stylus tip 204 at each end of the stylus 116. FIGS. 2B-2E provide side views of stylus tip 204 in accordance with at least some embodiments of the present disclosure. As depicted in at least FIG. 2A, the stylus tip 204 may comprise one or more members, or tubes, 208, 212, 216 that collapse into one another when an appropriate amount of pressure is applied to the stylus. For example, as a user applies additional pressure to the stylus 116, the applied pressure may counteract a biasing member 224 and cause one or more members 208, 212, 216 to collapse into another member 208, 212, 216, and 220. As the members 208, 212, and 216 collapse into another member 208, 212, 216, and 220, the member, or tube, contacting a touchscreen 108 may change. Such a change and/or the actual number of members contacting the touchscreen 108 may be detected and the electronic device 104 may initiate a response.

The biasing member 224 may include any material or device that provides a consistent, or varied, amount of force operable to maintain at least one member in a non-collapsed position. The biasing member 224 may include, but is not limited to a coil spring, a pneumatic piston, a fluid piston, a compliant material such as open and/or closed cell foam, rubber o-rings, and other similar materials or devices.

As illustrated in FIG. 2B, a first member 208 may make initial contact with a touchscreen 108. The initial contact of the first member 208 may be detected and may trigger a first response. As previously described, such a first response may provide blind users with a voiced description of an item, if any, being touched. For example, if the first member 208 of the stylus 116 touches a touchscreen 108 above an icon 112, the voiced description of the icon may be provided to the user. Alternatively, or in addition, the initial contact may trigger the electronic device 104 to selectively magnify the item being touched. For example, if the first member 208 of the stylus 116 touches a touchscreen 108 above an icon 112, the icon 112 may be selectively magnified, as illustrated in FIG. 1B. Alternatively, or in addition, such a first response may be consistent with a mouse-over event.

As illustrated in FIG. 2C, force, or pressure, applied to the stylus 116 in a downward direction may cause the biasing member 224 to compress, or otherwise deform, and cause the first member 208 to collapse into the second member 212 such that the second member 212, or tube, makes contact with the touchscreen 108. The additional contact between the second member 212 and the touchscreen 108, may be detected and may trigger a second response. As previously described, such a second response may cause the touched item to be activated. Alternatively, or in addition, the second response may make the item being touched ready for activation requiring another trigger response to actually activate the touched item. Alternatively, or in addition, such a first response may be consistent with a mouse left-click event.

As illustrated in FIG. 2D, additional force, or pressure, applied to the stylus 116 in a downward direction may cause the biasing member 224 to further compress, or otherwise deform, and cause the first member 208 and the second member 212 to collapse into a third member 216 such that the third member 216, or tube, makes contact with the touchscreen 108. The additional contact between the third member 216 and the touchscreen 108 may be detected and may trigger a third response. As one example, a third response may be equivalent to a mouse right-click event.

As illustrated in FIG. 2E, additional force, or pressure, applied to the stylus 116 in a downward direction may cause the biasing member 224 to compress, or otherwise deform, and cause the first member 208, the second member 212, and the third member 216 to collapse into a fourth member 220 such that the fourth member 220, or tube, makes contact with the touchscreen 108. The additional contact between the fourth member 216, and the touchscreen 108 may trigger a fourth response. As one example, a fourth response may be equivalent to a mouse double-click event.

If a user no longer applies a force, or pressure, in a downward direction, the biasing member 224 may expand such that each of the first member 208, second member 212, and third member 216 extend, or telescope, outward causing the stylus tip 204 to return to its non-collapsed state. In some instances, when the first member 208, second member 212, third member 216, and/or fourth member 220 are no longer in contact with the touchscreen 108, a fifth response may be generated. For example, an item that has been “readied for activation” may be activated when there is no contact between the touchscreen 108 and at least the second member 212. Of course, an item may be activated based on no contact between the touchscreen 108 and any of the one or more members 208-220.

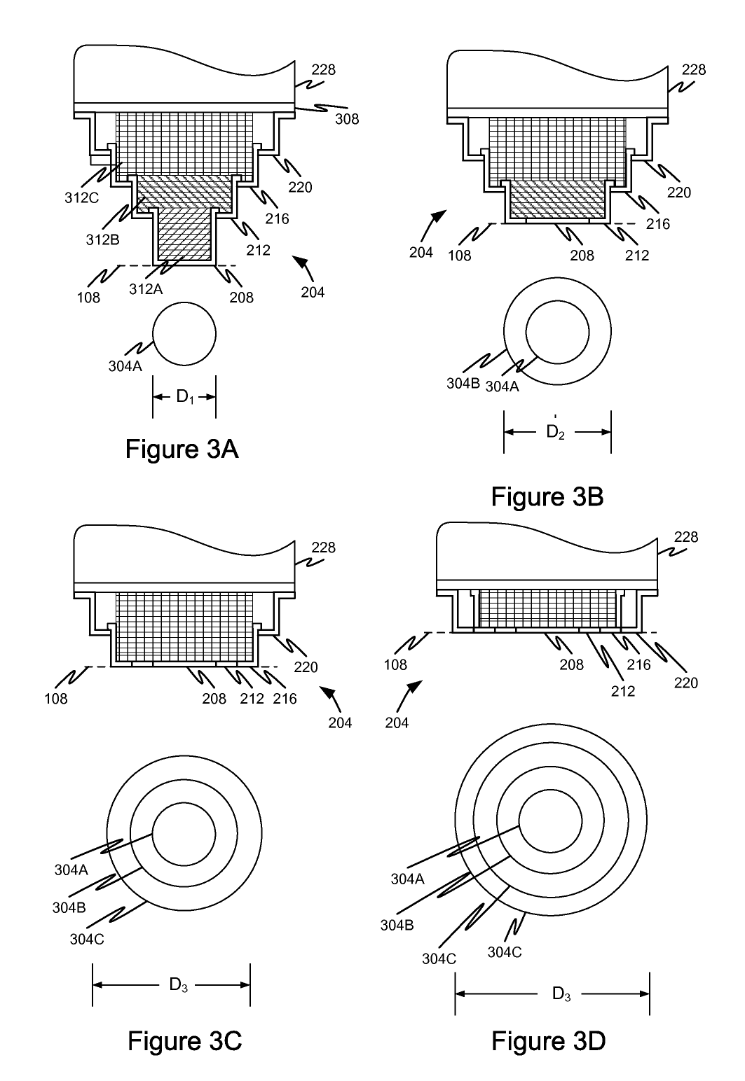

FIGS. 3A-3D provide a side view of stylus tip 204 in accordance with at least some embodiments of the present disclosure. Note that in the stylus tip 204 of FIGS. 3A-3D, portions configured similarly as in the case of FIGS. 2A-2E are denoted with the same reference characters, and the description of such portions have been omitted to avoid unnecessarily obscuring the present embodiments.

As depicted in at least FIG. 3A, the stylus tip 204 may comprise one or more members, or tubes, 208, 212, 216 that collapse into one another when an appropriate amount of pressure is applied to the stylus. For example, as a user applies additional pressure to the stylus 116, the applied pressure may counteract one or more biasing members 312A-C and cause one or more members 208, 212, 216 to collapse into another member 208, 212, 216, and 220. As the members 208, 212, and 216 collapse into another member 208, 212, 216, and 220, the member, or tube, contacting a touchscreen 108 may change. Such a change and/or the actual number of members contacting the touchscreen 108 may be detected and the electronic device 104 may initiate a response based on this detection.

A biasing member may be provided for each of the collapsible members; accordingly, a biasing member 312A may bias member 208 separately from the other members 212 and 216. Likewise, biasing member 312B may bias member 212 separately from the other members 208 and 216. Similarly, biasing member 312C may bias member 216 separately from the other members 208 and 216. Each biasing member may occupy an interstitial space between a collapsible member and another member. For example, biasing member 312B may be disposed between collapsible member 312A and 312C and biasing member 312C may be disposed between collapsible member 216 and member 220. Similarly, each biasing member may occupy an interstitial space between a collapsible member and the end of the stylus tip closest to the stylus body 228, for example, portion 308. That is, biasing member 312A may be disposed between collapsible member 208 and portion 308; biasing member 312B may be disposed between collapsible member 212 and portion 308; and biasing member 312C may be disposed between collapsible member 216 and portion 308. Each biasing member 312A-C may include any material or device that provides a consistent, or varied, amount of force operable to maintain at least one member in a non-collapsed position. The biasing members 312A-C may include, but are not limited to coil springs, pneumatic pistons, fluid pistons, compliant materials such as open and/or closed cell foams, rubber o-rings, and other similar materials or devices. Additionally, the material or device comprising biasing members may be different. For example, biasing member 312A may include a coil spring while biasing member 312C may include a rubber o-ring.

As depicted in at least FIG. 3A, a first member 208 may make initial contact with a touchscreen 108. Such initial contact may have or otherwise be associated with a footprint 304A having a measurement of D₁. D₁ may correspond to a diameter of the footprint 304A; alternatively, or in addition, D₁ may correspond to another measureable attribute of footprint 304A, such as area, length, width, etc. . . . The initial contact of the first member 208 may be detected and may trigger a first response. For example, the footprint 304A corresponding to the first member 208 may be detected and compared to one or more stored footprints. If the detected footprint 304A matches a stored footprint, the first response may be triggered. The first response may be the same as or similar to the first response described with respect to FIG. 2B.

As illustrated in FIG. 3B, force, or pressure, applied to the stylus 116 in a downward direction may cause the biasing member 312A to compress, or otherwise deform, and cause the first member 208 to collapse into the second member 212 such that the second member 212, or tube, makes contact with the touchscreen 108. The additional contact of the second member 212 may have or otherwise be associated with a footprint 304B having a measurement of D₂. D₂ may correspond to a diameter of the footprint 304A; alternatively, or in addition, D₂ may correspond to another measureable attribute of footprint 304A, such as area, length, width, etc. . . . The additional contact between the second member 212 and the touchscreen 108, may be detected and may trigger a second response. For example, the footprint 304B corresponding to the second member 212 may be detected and compared to one or more stored footprints. If the detected footprint 304B matches a stored footprint, the second response may be triggered. Alternatively, or in addition, the footprint 304B comprising footprints 304A and 304B corresponding to the second member 212 may be detected and compared to one or more stored footprints. If the detected footprint 304B comprising footprints 304A and 304B matches a stored footprint, the second response may be triggered. The second response may be the same as or similar to the second response described with respect to FIG. 2C.

As illustrated in FIG. 3C, additional force, or pressure, applied to the stylus 116 in a downward direction may cause the biasing members 312A and 312B to further compress, or otherwise deform, and cause the first member 208 and the second member 212 to collapse into a third member 216 such that the third member 216, or tube, makes contact with the touchscreen 108. The additional contact of the third member 216 may have or otherwise be associated with a footprint 304C having a measurement of D₃. D₃ may correspond to a diameter of the footprint 304A; alternatively, or in addition, D₃ may correspond to another measureable attribute of footprint 304A, such as area, length, width, etc. . . . The additional contact between the third member 216 and the touchscreen 108, may be detected and may trigger a third response. For example, the footprint 304C corresponding to the third member 216 may be detected and compared to one or more stored footprints. If the detected footprint 304C matches a stored footprint, the third response may be triggered. Alternatively, or in addition, the footprint 304C comprising one or more of footprints 304A and 304B, and also including 304C corresponding to the third member 216 may be detected and compared to one or more stored footprints. If the detected footprint 304C comprising one or more of footprints 304A and 304B, and also including 304C matches a stored footprint, the third response may be triggered. The third response may be the same as or similar to the second response described with respect to FIG. 2D.

As illustrated in FIG. 3D, additional force, or pressure, applied to the stylus 116 in a downward direction may cause the biasing members 312A-312C to further compress, or otherwise deform, and cause the first member 208, the second member 212, and the third member 216 to collapse into a fourth member 220 such that the fourth member 220, or tube, makes contact with the touchscreen 108. The additional contact of the fourth member 220 may have or otherwise be associated with a footprint 304D having a measurement of D₄. D₄ may correspond to a diameter of the footprint 304A; alternatively, or in addition, D₄ may correspond to another measureable attribute of footprint 304A, such as area, length, width, etc. . . . The additional contact between the fourth member 220 and the touchscreen 108, may be detected and may trigger a fourth response. For example, the footprint 304D corresponding to the fourth member 220 may be detected and compared to one or more stored footprints. If the detected footprint 304D matches a stored footprint, the fourth response may be triggered. Alternatively, or in addition, the footprint 304D comprising one or more of footprints 304A, 304B, 304C, and also including 304D corresponding to the fourth member 220 may be detected and compared to one or more stored footprints. If the detected footprint 304D comprising one or more of footprints 304A, 304B, 304C, and also including 304D matches a stored footprint, the fourth response may be triggered. The fourth response may be the same as or similar to the second response described with respect to FIG. 2E.

If a user no longer applies a force, or pressure, in a downward direction, the biasing members 312A-312C may expand such that each of the first member 208, second member 212, and third member 216 extend, or telescope, outward causing the stylus tip 204 to return to its non-collapsed state. In some instances, when the first member 208, second member 212, third member 216, and/or fourth member 220 are no longer in contact with the touchscreen 108, a fifth response may be generated. For example, an item that has been “readied for activation” may be activated when there is no contact between the touchscreen 108 and at least the second member 212. Of course, an item may be activated based on there being no contact between the touchscreen 108 and any of the one or more members 208-220.

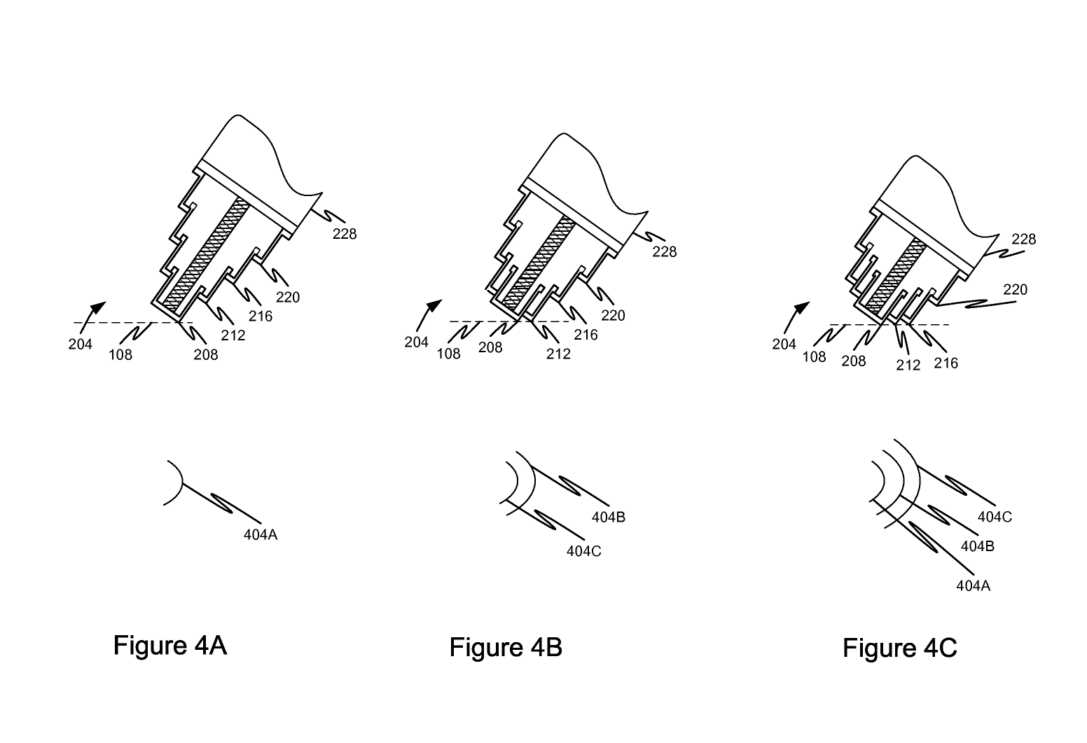

FIGS. 4A-4C provide a side view of stylus tip 204 in accordance with at least some embodiments of the present disclosure. Note that in the stylus tip 204 of FIGS. 4A-4C, portions configured similarly as in the case of FIGS. 2A-3D are denoted with the same reference characters, and the description of such portions have been omitted to avoid unnecessarily obscuring the present embodiments.

As depicted in at least FIG. 4A, the stylus tip 204 may make contact with the touchscreen 108 on an angle. In such instances, the footprint detected may not correspond to an entirety of member 208, member 212, member 216, and/or member 220. For instance, the detected footprint may not be a round shape, such as previously illustrated with reference to FIGS. 2A-3D. Instead, such a detected footprint may resemble 404A, where a portion of member 208 is detected. That is, the detected footprint may correspond to a portion of member 208 contacting the touchscreen 108 on an angle. Regardless of whether the detected footprint is a portion of a member 208, 212, 261 and/or 220, the touchscreen based user input system 100 may detect the contact and/or footprint and generate a response. For example, as illustrated in FIG. 4A, a first member 208 may make initial contact with a touchscreen 108. Such initial contact may have or otherwise be associated with a footprint 404A. The initial contact of the first member 208 may be detected and may trigger a first response. For example, the footprint 404A corresponding to the first member 208 may be detected and compared to one or more stored footprints. If the detected footprint 404A matches a stored footprint, the first response may be triggered. The first response may be the same as or similar to the first response described with respect to FIG. 2B.

As illustrated in FIG. 4B, force, or pressure, applied to the stylus 116 in a downward direction may cause the biasing member to compress, or otherwise deform, and cause the first member 208 to collapse into the second member 212 such that the second member 212, or tube, makes contact with the touchscreen 108. The additional contact of the second member 212 may have or otherwise be associated with a footprint 404B. The additional contact between the second member 212 and the touchscreen 108, may be detected and may trigger a second response. For example, the footprint 404B corresponding to the second member 212 may be detected and compared to one or more stored footprints. If the detected footprint 404B matches a stored footprint, the second response may be triggered. Alternatively, or in addition, the footprint 404B comprising footprints 404A and 404B corresponding to the second member 212 may be detected and compared to one or more stored footprints. If the detected footprint 404B comprising footprints 404A and 404B matches a stored footprint, the second response may be triggered. The second response may be the same as or similar to the second response described with respect to FIG. 2C.

As illustrated in FIG. 4C, additional force, or pressure, applied to the stylus 116 in a downward direction may cause the biasing member to further compress, or otherwise deform, and cause the first member 208 and the second member 212 to collapse into a third member 216 such that the third member 216, or tube, makes contact with the touchscreen 108. The additional contact of the third member 216 may have or otherwise be associated with a footprint 404C. The additional contact between the third member 216 and the touchscreen 108, may be detected and may trigger a third response. For example, the footprint 404C corresponding to the third member 216 may be detected and compared to one or more stored footprints. If the detected footprint 404C matches a stored footprint, the third response may be triggered. Alternatively, or in addition, the footprint 404C comprising one or more of footprints 404A and 404B, and also including 404C corresponding to the third member 216 may be detected and compared to one or more stored footprints. If the detected footprint 404C comprising one or more of footprints 404A and 404B, and also including 404C matches a stored footprint, the third response may be triggered. The third response may be the same as or similar to the third response described with respect to FIG. 2D.

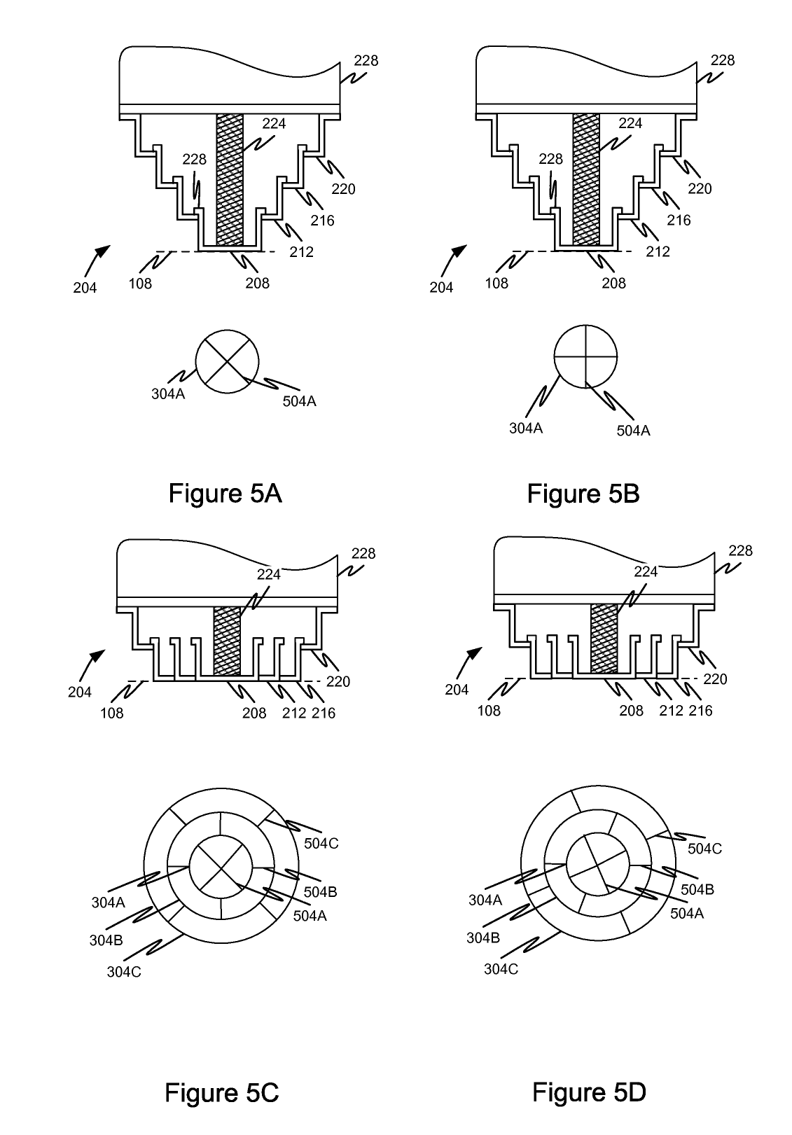

FIGS. 5A-5D provide a side view of stylus tip 204 in accordance with at least some embodiments of the present disclosure. Note that in the stylus tip 204 of FIGS. 5A-5D, portions configured similarly as in the case of FIGS. 2A-4C are denoted with the same reference characters, and the description of such portions have been omitted to avoid unnecessarily obscuring the present embodiments.

FIGS. 5A-5D differ from FIGS. 2A-2D in that, in addition to detecting members 208, 212, 216, and 220, a touchscreen based user input system 100 may also detect a rotation, orientation, and/or motion of each member 208, 212, 216, and 220. That is, one or more members 208, 212, 216, and 220 may be rotary encoded. As one example, FIG. 5A depicts a member 208 having a rotary encoded pattern 504A; the touchscreen based user input system may detect the rotary encoded pattern 504A such that if the stylus 116 were rotated and/or the orientation is changed, such as in FIG. 5B, the change would be detected. Similarly, FIG. 5C depicts a member 208, 212, and 216 having a rotary encoded patterns 504A, 504B, and 504C respectively. The touchscreen based user input system may detect the rotary encoded pattern 504A, 504B, and 504C from the footprints 304, 304B, and 304C respectively. If the stylus 116 were rotated and/or the orientation is changed, such as in FIG. 5D, the change would be detected.

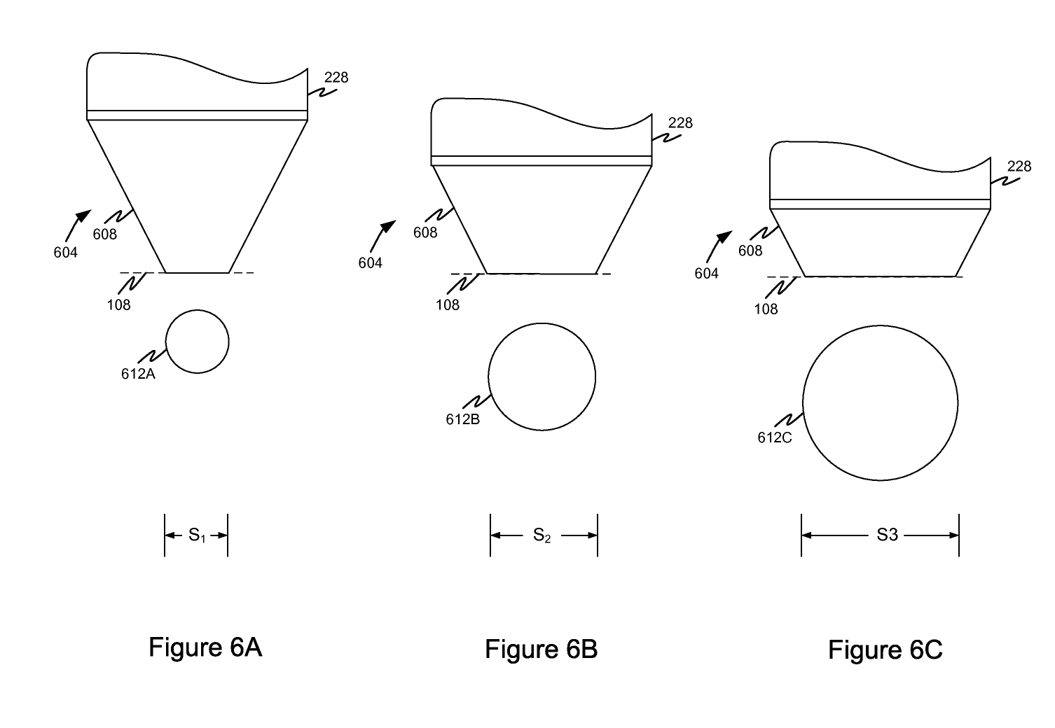

FIGS. 6A-6C provide a side view of stylus tip 604 in accordance with at least some embodiments of the present disclosure. Note that in the stylus tip 604 of FIGS. 6A-6C, portions configured similarly as in the case of FIGS. 2A-5D are denoted with the same reference characters, and the description of such portions have been omitted to avoid unnecessarily obscuring the present embodiments.

The stylus 116 may include a stylus tip 604 provided at one end of a stylus body 228 belonging to the stylus 116. Although not illustrated, it is contemplated that stylus 116 may further include a stylus tip 604 at each end of the stylus 116. As depicted in at least FIG. 6A, the stylus tip 604 may comprise a cone shaped member 608 made of one or more compliant materials. For example, the material of cone shaped member 608 may comprise, but is not limited to, one or more of rubber or similar material, open and/or closed cell foam, and an inflated material such as a balloon filled with liquid, gas, and/or powder. As member 608 makes initial contact with a touchscreen 108, the initial contact of the member 608 may be detected and may trigger a first response. Such initial contact may have or otherwise be associated with a footprint 612A having a width S₁. Alternatively, or in addition, the initial contact may have or otherwise be associated with a footprint 612A having other measurable attributes. For example, other measurable attributes may include length, area, circumference, etc. . . . The footprint 612A may be detected and compared to one or more footprints. If the detected footprint 612A matches a stored footprint, the first response may be triggered. The first response may be the same as or similar to the first response described with respect to FIG. 2B.

As illustrated in FIG. 6B, force, or pressure, applied to the stylus 116 in a downward direction may cause member 608 to compress, or otherwise deform. In some instances, the member 608 may compress into itself. In other instances, the member 608 may simply compress. Regardless of how member 608 deforms, a footprint 612B having a width S₂ may be detected and may trigger a second response. Alternatively, or in addition, the footprint 612B may have other measurable attributes. For example, other measurable attributes may include length, area, circumference, etc. . . . The footprint 612B may be detected and compared to one or more footprints. If the detected footprint 612B matches a stored footprint, the second response may be triggered. The second response may be the same as or similar to the second response described with respect to FIG. 2C.

As illustrated in FIG. 6C, additional force, or pressure, applied to the stylus 116 in a downward direction may cause member 608 to compress, or otherwise deform. In some instances, the member 608 may compress into itself. In other instances, the member 608 may simply compress. Regardless of how member 608 deforms, a footprint 612C having a width S₃ may be detected and may trigger a third response. Alternatively, or in addition, the footprint 612C may have other measurable attributes. For example, other measurable attributes may include length, area, circumference, etc. . . . For example, the footprint 612C may be detected and compared to one or more stored footprints. If the detected footprint 612C matches a stored footprint, the third response may be triggered. The third response may be the same as or similar to the second response described with respect to FIG. 2D.

As previously discussed, the detected footprint 612A-C may be compared to one or more stored footprints such that if the detected footprint 612A-C matches the stored footprint, a specific response may be triggered. Accordingly, a calibration and/or initialization procedure may be utilized to identify one or more responses to be triggered based on the detected footprint. For example, the touchscreen based user input system 100 may prompt a user to associate a particular footprint to one or more responses. Specifically, a user may choose a particular response, such as the second response, and apply an amount of pressure, or force, to the stylus 116 such that the stylus member 608 contacts the touchscreen 108 and deforms, or compresses, to achieve a desired footprint. The desired footprint may then be associated with the particular response and stored by the touchscreen based user input system 100. Accordingly, when the desired footprint is later detected by the touchscreen based user input system 100, the associated response may be triggered. That is, each response may be associated with a discrete step or response identified by a corresponding footprint.

Alternatively, or in addition, the stylus tip 604 may provide continuous variation as opposed to one or more discrete steps or discrete responses. For instance, as pressure may be applied to a stylus 116, the stylus tip 604 deforms in a smooth, predictable way depending on the pressure applied. Accordingly, a touchscreen based user input system 100 may support smooth user-controlled adjustments. That is, the amount of adjustment may be proportional to the measured deformation of the stylus tip 604. For example, the deforming stylus tip 604 may be used in a manner similar to the way one might use a potentiometer on an old-style device to control functions such as volume or brightness control. As another example, the deforming stylus tip 604 may also control other functions, such as but not limited to a magnification level, text and/or numeric input, and screen/page navigation.

In accordance with at least some embodiments of the present disclosure, a calibration and/or initialization procedure may be utilized to associate a measured amount of deformation of a stylus tip 604 to one or more smooth user-controlled adjustments. For example, as member 608 makes initial contact with a touchscreen 108, the initial contact of the member 608 may be detected as a footprint 612A having a width S₁ and may represent a low amount of stylus tip deformation. As additional force, or pressure, is applied to the stylus 116, the stylus tip may cause member 608 to further compress, or otherwise deform. Thus, the detected footprint, such as footprint 612C having a width S₃, may represent a high amount of stylus tip deformation. Accordingly, when controlling functions using smooth continuous adjustments, as pressure is applied to the stylus 116 and as pressure is released from the stylus 116, the deformation of the stylus tip, as measured by the size of the detected footprint, may be between the low amount of stylus tip deformation as provided by footprint 612A and the high amount of stylus tip deformation as provided by footprint 612C. For example, the footprint 612B having a size S₂ is between footprint 612A and 612C. Thus, by using the size of the detected footprint, in proportion to the size of the footprints for a low and high amount of stylus tip deformation, continuous smooth user-controlled adjustments may be provided by a stylus.

As one example of a smooth user-controlled adjustment, a user contacting touchscreen 108 directly above an icon 112 using a stylus 116 may cause the icon 112 to become magnified. As the user applies more pressure to the stylus 116, the stylus tip 604 increases in size as it deforms in a smooth controlled manner such that an amount of magnification may become greater. As the user applies less pressure to the stylus 116, the stylus tip 604 decreases in size as it deforms in a smooth controlled manner such that the amount of magnification may be less.

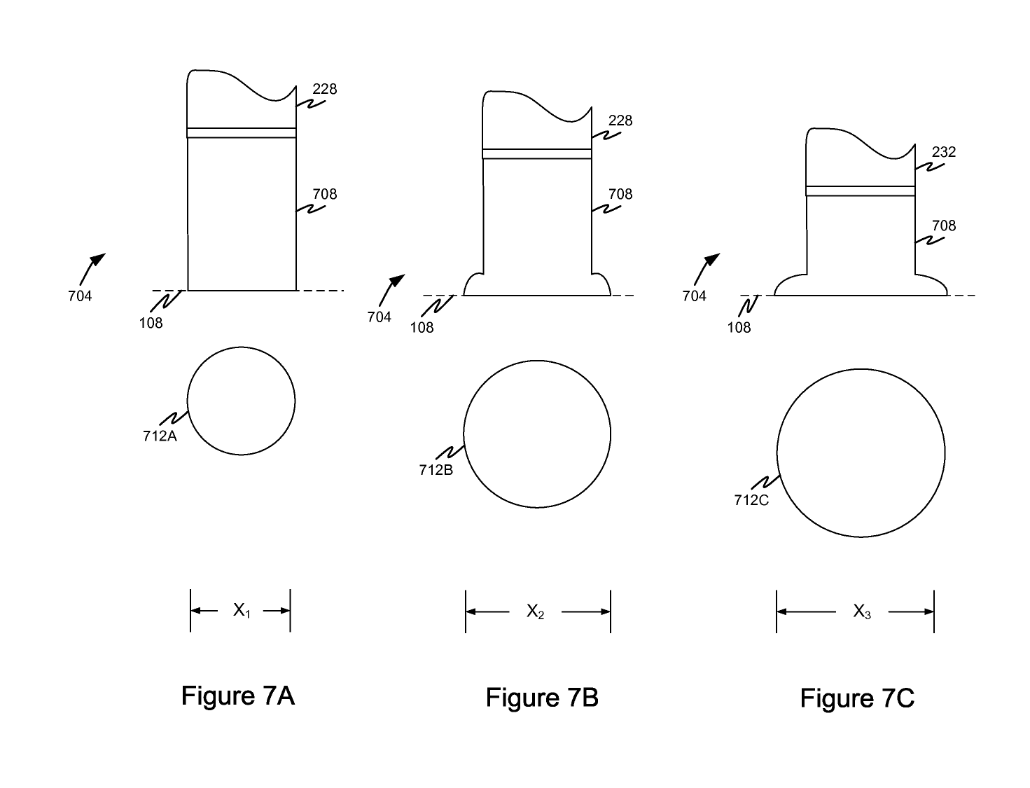

FIGS. 7A-7C depict a stylus configuration in accordance with at least some embodiments of the present disclosure. FIGS. 7A-7C differ from FIGS. 6A-6C in that the stylus tip member 704 may be shaped as a cylinder. Accordingly, as pressure is applied to the stylus 116 such that the stylus tip 704 deforms when contacting a touchscreen 108, the deformation may resemble FIGS. 7A-7C and having footprints 712A-712C. Thus, although the stylus tip 704 deforms in a different manner than that of stylus tip 604, the description of FIGS. 6A-6C equally applies to that of FIGS. 7A-7C.

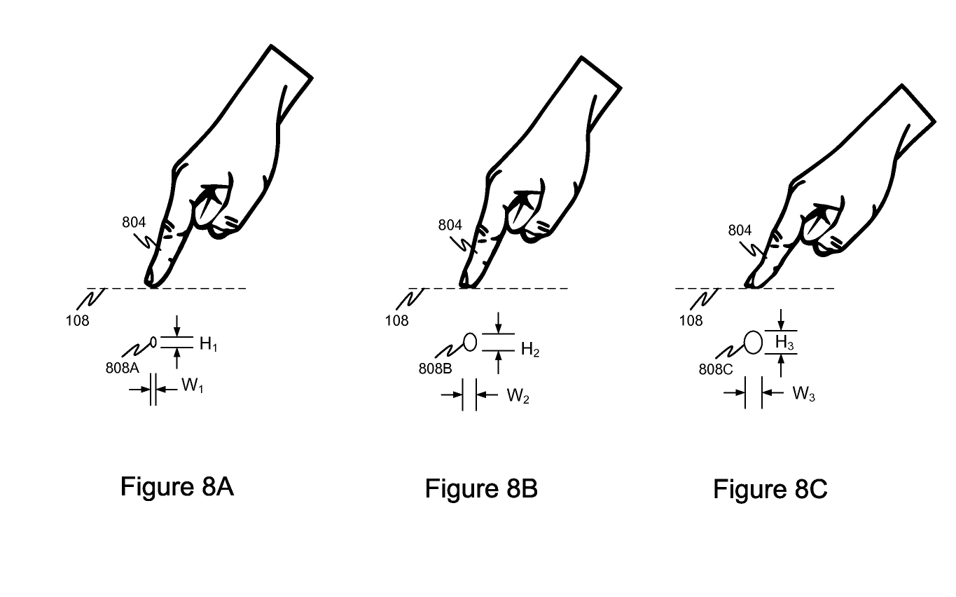

FIGS. 8A-8C depict an example where the input device is a finger in accordance with at least some embodiments of the present disclosure. As a finger 804 makes initial contact with a touchscreen 108, the initial contact of the finger 804 may be associated with a footprint 808A having a width W₁ and a height H₁. For example, the footprint 808A may be detected and compared to one or more footprints. If the detected footprint 808A matches a stored footprint, the first response may be triggered. The first response may be the same as or similar to the first response described with respect to FIG. 2B.

As illustrated in FIG. 8B, as force, or pressure, increases on the finger 804, the finger 804 may deform such that the footprint associated with finger 804 increases in size. Thus, a footprint 808B having a width S₂ and a height H₂ may be detected and may trigger a second response. For example, the footprint 808B may be detected and compared to one or more footprints. If the detected footprint 808B matches a stored footprint, the second response may be triggered. The second response may be the same as or similar to the second response described with respect to FIG. 2C.

As illustrated in FIG. 8C, as additional force, or pressure, increases on the finger 804, the finger 804 may deform such that the footprint associated with finger 804 further increases in size. Thus, a footprint 808C having a width S₃ and a height H₃ may be detected and may trigger a third response. For example, the footprint 808C may be detected and compared to one or more footprints. If the detected footprint 808C matches a stored footprint, the third response may be triggered. The third response may be the same as or similar to the second response described with respect to FIG. 2D.

As previously discussed, the detected footprint 808A-C may be compared to one or more stored footprints such that if the detected footprint 808A-C matches the stored footprint, a specific response may be triggered. Accordingly, a calibration and/or initialization procedure may be utilized to identify one or more responses to be triggered based on the detected footprint. For example, the touchscreen based user input system 100 may prompt a user to associate a particular footprint to one or more responses. Specifically, a user may choose a particular response, such as the first response, and contact the touchscreen 108 with their finger 804 such that a desired, e.g. size of footprint, is achieved. The desired footprint may then be associated with the particular response and stored by the touchscreen based user input system 100. Accordingly, when the desired footprint is later detected by the touchscreen based user input system 100, the associated response may be triggered. That is, each response may be associated with a discrete step or response identified by a footprint.

Alternatively, or in addition, the finger 804 may provide continuous variation as opposed to one or more discrete steps or discrete responses. For instance, as pressure is applied to the finger 804, the finger 804 deforms in a smooth, predictable way depending on the pressure applied. That is, the portion of finger 804 in contact with the touchscreen 108 increases in size. Accordingly, a touchscreen based user input system 100 may support smooth user-controlled adjustments. That is, the amount of adjustment may be proportional to the measured deformation of the finger 804. For example, the amount of deformation of the portion of the finger 804 that is in contact with the touchscreen 108 may be used in a manner similar to the way one might use a potentiometer on an old-style device to control functions such as volume or brightness control. As another example, the finger 804 may also control other functions, such as but not limited to a magnification level, text and/or numeric input, and screen/page navigation.

In accordance with at least some embodiments of the present disclosure, a calibration and/or initialization procedure may be utilized to associate a measured amount of deformation of the finger 804 to one or more smooth user-controlled adjustments. For example, as a portion of the finger 804 contacts the touchscreen 108, the contact may be detected as a footprint 808A having a width W₁ and a height H₁; this footprint may represent a low amount of finger deformation as W₁ and H₁ may not be large. As additional force, or pressure, is applied to the finger 804, the portion of the finger 804 in contact with the touchscreen 108 deforms. Thus, the detected footprint, such as footprint 808C having a width W₃ and a height H₃, may represent a high amount finger 804 deformation as W₃ and H₃ are greater than W₁ and H₁. Accordingly, when controlling functions using smooth continuous adjustments, as pressure is applied to the finger 804 and as pressure is released from the finger 804, the deformation of the finger, as measured by the size of the detected footprint, may fall between the low amount of finger deformation as provided by footprint 808A and the high amount of finger deformation as provided by footprint 808C. For example, the footprint 808B having a size with measurements of W₂ and H₂ is between footprint 808A and 808C. Thus, by using the size of the detected footprint, in proportion to the size of the footprints for a low and high amount of finger deformation, continuous smooth user-controlled adjustments may be provided by a finger.

Similar to FIGS. 6A-C, one example of a smooth user-controlled adjustment using a finger may be in an instance where a user contacts the touchscreen 108 directly above an icon 112 using their finger 804. Such contact may cause the icon 112 to become magnified. As the user applies more pressure to their finger 804, the portion of the finger 804 in contact with the touchscreen 108 increases in size as it deforms in a smooth controlled manner such that an amount of magnification may become greater. As the user applies less pressure to their finger 804, the portion of the finger 804 in contact with the touchscreen 108 decreases in size as it deforms in a smooth controlled manner such that the amount of magnification may be less.

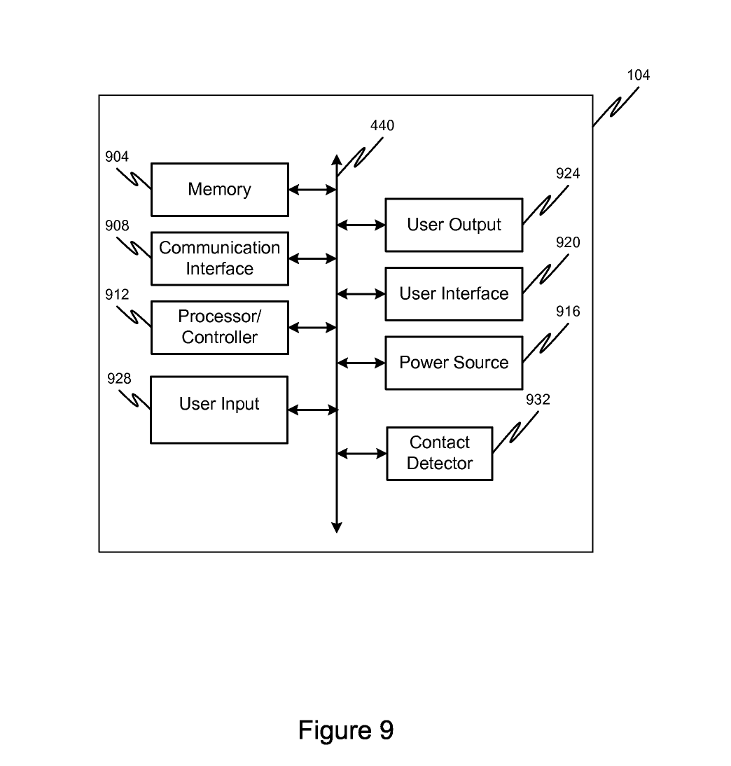

FIG. 9 illustrates a block diagram depicting one or more components of an electronic device 104. In some embodiments, the electronic device 104 may include a processor/controller 912 capable of executing program instructions. The processor/controller 912 may include any general purpose programmable processor or controller for executing application programming. Alternatively, or in addition, the processor/controller 912 may comprise an application specific integrated circuit (ASIC). The processor/controller 912 generally functions to execute programming code that implements various functions performed by the associated server or device. The processor/controller 912 of the electronic device 104 may operate to initiate and establish a communication session.

The electronic device 104 may additionally include memory 904. The memory 904 may be used in connection with the execution of programming instructions by the processor/controller 912, and for the temporary or long term storage of data and/or program instructions. For example, the processor/controller 912, in conjunction with the memory 904 of the electronic device 104, may implement footprint detection and matching used by or accessed by the electronic device 104.

The memory 904 of the electronic device 104 may comprise solid state memory that is resident, removable and/or remote in nature, such as DRAM and SDRAM. Moreover, the memory 904 may comprise a plurality of discrete components of different types and/or a plurality of logical partitions. In accordance with still other embodiments, the memory 904 comprises a non-transitory computer readable storage medium. Such a medium may take many forms, including but not limited to, non-volatile media, volatile media, and transmission media.

The electronic device 104 may further include user input 928, a user output 924, a user interface 920, a communication interface 908, an optional power source 916, a contact detector 932, and a footprint data store 936. The communication interface 908 may comprise a GSM, CDMA, FDMA and/or analog cellular telephony transceiver capable of supporting voice, multimedia and/or data transfers over a cellular network. One or more components of the electronic device 104 may communicate with another utilizing a communications bus 940. Alternatively, or in addition, the communication interface 908 may comprise a Wi-Fi, BLUETOOTH™, WiMax, infrared, NFC or other wireless communications link. The communication interface 408 may be associated with one or more shared or a dedicated antennas. The type of medium used by the electronic device 104 to communicate with other electronic devices and/or network equipment, may depend upon the communication applications availability on the electronic device 104 and/or the availability of the communication medium.

The electronic device 104 may include a user interface 920 allowing a user to interact with the electronic device 104. For example, the user may be able to utilize stylus 116 to select an icon 112 and/or cause the icon 112 to become magnified, wherein the icon is displayed according to the configuration of the user interface. Additionally, the user may be able to utilize stylus 116 to invoke an action consistent with a first response, a second response, a third response, and/or a forth response, for example. Examples of user input devices 928 include a keyboard, a numeric keypad, a touchscreen 108, a microphone, scanner, a stylus, and a pointing device combined with a screen or other position encoder. Examples of user output devices 924 include a display, a touchscreen display 108, a speaker, and a printer.

The contact detector 932 may comprise one or more sensors that detect and/or measure contact between a stylus 116 and the touchscreen 108. For example, the contact detector 932 may communicate with the touchscreen 108 and receive contact information comprising one or more locations of the contact. The contact detector 932 may then evaluate the contact received to determine whether or not the contact corresponds to one or more members of the stylus 116. As one example, the contact detector 932 may compare the contact information to one or more stored footprints located in the footprint store 936. Alternatively, or in addition, the contact detector 932 may employ one or more algorithms to determine if the contact information corresponds to one or more members of the stylus tip 204 belonging to a stylus 116. Alternatively, or in addition, the contact sensor 932 may employ one or more algorithms to determine if the contact information indicates a footprint associated with the contact is increasing or decreasing. Further still, the contact detector 932 may determine that a first response, second response, third response, and/or fourth response is to be activated or invoked and communicate such indication to one or more components of the electronic device 104, for example, the processor/controller 912.

Footprints may be loaded into footprint store 936 using a variety of methods. For instance, one or more footprints may correspond to a calibration process in which a user, interacting with a stylus, stores one or more footprints associated with one or more actions. Alternatively, or in addition, footprints may be loaded upon installing one or more drivers for use with a specified stylus 116.

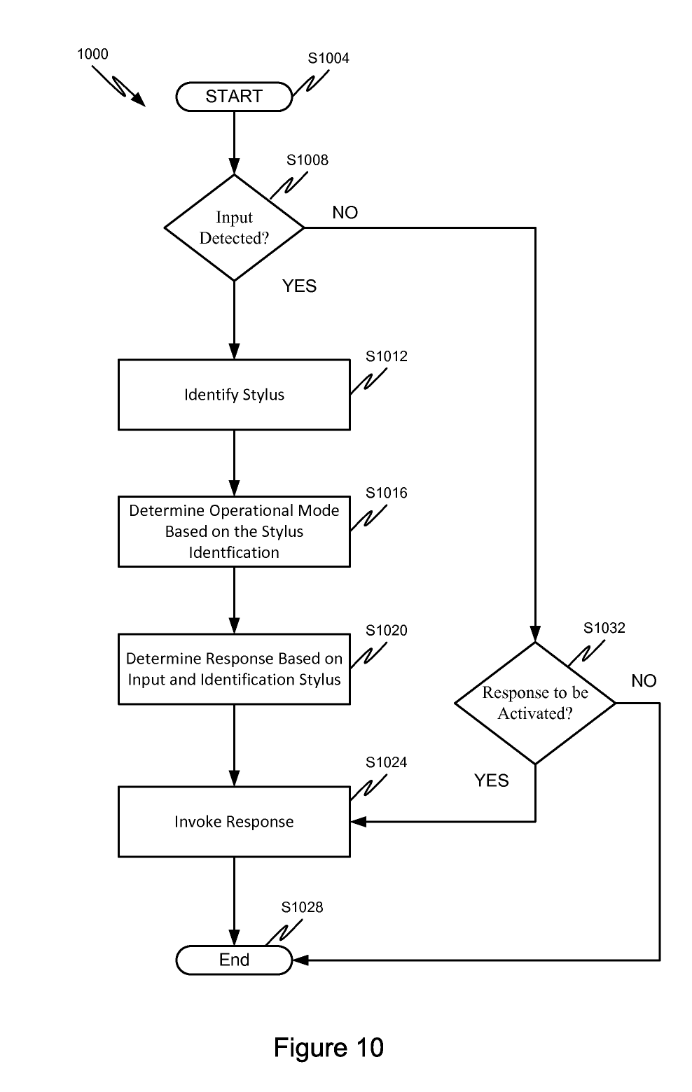

Referring now to FIG. 10, a method 1000 of detecting an input and determining a response will be discussed in accordance with embodiments of the present disclosure. Method 1000 is in embodiments, performed by a device, such as an electronic device 104, and/or more specifically, the contact detector 932. More specifically, one or more hardware and software components may be involved in performing method 1000. In one embodiment, one or more of the previously described devices perform one or more of the steps of method 1000. The method 1000 may be executed as a set of computer-executable instructions executed by an electronic device 104 and encoded or stored on a computer-readable medium. Hereinafter, the method 1000 shall be explained with reference to systems, components, modules, software, etc. described with FIGS. 1-9.

Method 1000 may continuously flow in a loop, flow according to a timed event, or flow according to a change in an operating or status parameter. Method 1000 is initiated at step S1004 where a user may turn on or otherwise perform some action with respect to the electronic device 104. For example, a user may power on the electronic device 104, may initiate an application, and/or may cause method 1000 to begin. Alternatively, or in addition, step S1004 may be initiated when a user activates or otherwise interacts with an electronic device 104. At step S1008, method 1000 determines if there has been an input detected. In accordance with some embodiments, the touchscreen 108 and/or the contact detector 928 may determine if an input has been detected. If input has been detected, the electronic device 104 identifies the stylus. For example, the stylus may be identified based on the stylus tip 204, 608, 708. The stylus tip may be identified based on one or more distinguishing factors. Such distinguishing factors may include, but are not limited to: (1) a size of the members, for example members 208, 212, 216, and 220 may be larger or smaller and having a different detectable area depending on a stylus; (2) the number of members, for example, a stylus tip 204 may comprise three members 208, 212, and 216; (3) the presence of an encoded and/or patterned member and/or identifying information based on the encoded and/or patterned member; (4) a distance between members, for example the distance between members 208, 212, 216 may vary according to a stylus tip type; (5) a shape of the members, for example, members 208, 212, 216, and 220 may be circular, oval, etc.; and (6) a stylus identifier. Based on the stylus identification, an operational mode may be determined at step S1016. As one example, if the stylus is identified as a low-vision stylus, a low-vision operational mode may be entered. As another example, if the stylus is identified as a stylus for use by a blind user, a blind-user operational mode may be entered. The contact detector 232 and/or controller 912 determines a response based on the detected input at step S1008, the identification of the stylus at step S1012, and/or the operational mode determined at step S1016; this determined response may occur at step S1020. For example, the contact detector 232 and/or controller 912 may determine that a first member 208 of a stylus 116 contacted touchscreen 108. The contact detector may then determine that based on an operational mode, the detected contact is consistent or otherwise associated with a first response. Then, at step S1024, the method 1000 may invoke or otherwise execute the determined response. For example, the method 1000 may determine that the detected input is consistent with a first response. The contact detector 928 may then determine that a magnification of an icon 212 is needed. Thus, at step S1024, method 1000 initiates a magnification of the icon. Method 1000 then ends at step S1028.

If input is not detected at step S1008, the method may flow to step S1032 where it is determined whether or not a previously determined response needs to be activated. For example, in some embodiments consistent with the present disclosure, the response determined at step S1020 may not be invoked until an input is not detected at the touchscreen 108. For example, and as previously mentioned with respect to FIGS. 2A-E, the detection of an input may correspond to readying a response for activation; however, the response is not actually activated until input is not detected. Thus, if a previously determined response is to be activated at step S1028, method 1000 proceeds to step S1024 where the response is then activated and/or executed. If there is no response to be activated, method 1000 proceeds to step S1028 where method 1000 ends.

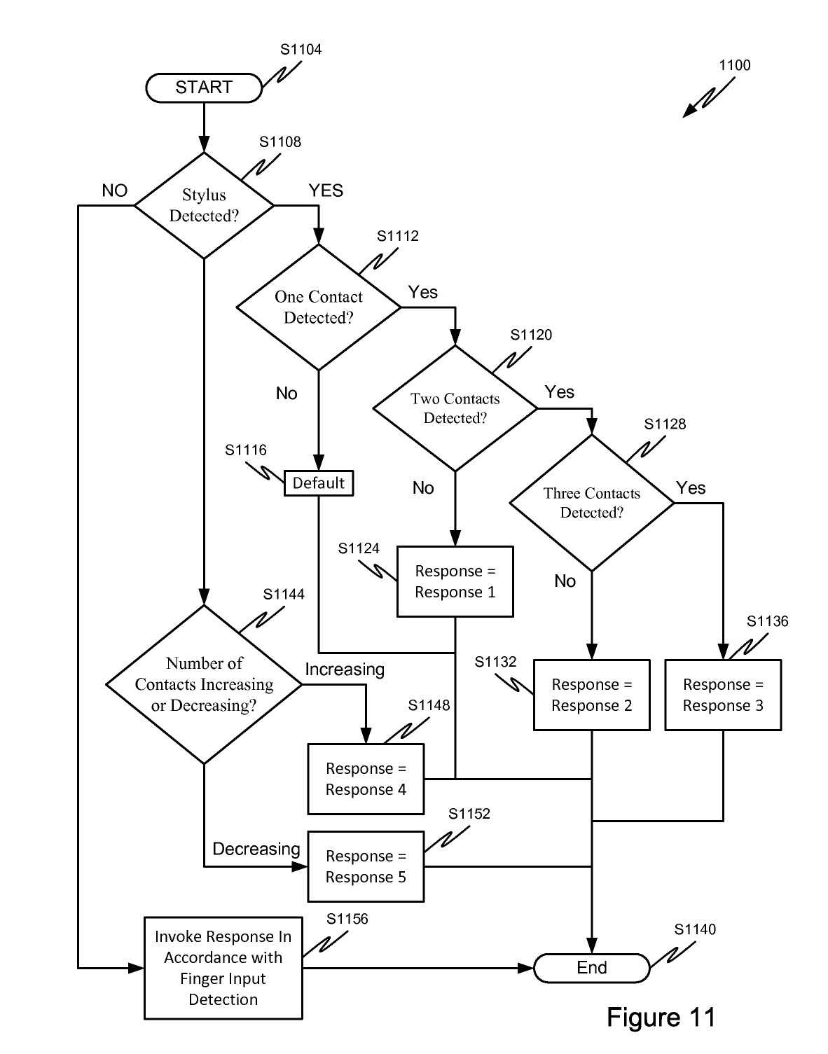

Referring now to FIG. 11, a method 1100 of detecting an input and determining a response will be discussed in accordance with embodiments of the present disclosure. Method 1100 is in embodiments, performed by a device, such as an electronic device 104, and/or more specifically, the contact detector 932. More specifically, one or more hardware and software components may be involved in performing method 1100. In one embodiment, one or more of the previously described devices perform one or more of the steps of method 1100. The method 1100 may be executed as a set of computer-executable instructions executed by an electronic device 104 and encoded or stored on a computer-readable medium. Hereinafter, the method 1100 shall be explained with reference to systems, components, modules, software, etc. described with FIGS. 1-10.

Method 1100 may continuously flow in a loop, flow according to a timed event, or flow according to a change in an operating or status parameter. Method 1100 is initiated at step S1104 where, for example, method 1000 may have detected input at step S1008. Method 1100 then proceeds to step S1108 where method 1100 determines whether a stylus has been detected. If a stylus has been detected at step S1108, method 1100 may proceed step S1112 where method 1100 determines whether a single contact has been detected, wherein a contact is contact between a stylus 116 and the touchscreen 108. For example, a first member of a stylus may make an initial contact with a touchscreen 108. The initial contact of the first member of the stylus 116 may be detected at step S1112. If a single contact was not detected at step S1112, then method 1100 proceeds to step S1116 where a default action may be taken. For example, if input was detected at step S1008, however no stylus was detected at step S1108 and a single contact was not detected at step S1112, then a default action, perhaps that notifies the user of such an incident may occur at step S1116. Method 1100 then proceeds from step S1116 to step S1140 where the method ends. Alternatively, if one contact was detected at step S1112, method 1100 proceeds to step S1120 where method 1100 determines whether two contacts are detected.

If, at step S1120, two contacts are not detected, method 1100 proceeds to steps S1124 where a first response is determined based on the detected single contact. Method 1100 then proceeds to step S1140. If, however, two contacts are detected at step S1120, method 1100 proceeds to step S1128 to determine if three contacts have been detected. If three contacts have not been detected at step S1128, method 1100 proceeds to steps S1132 where a second response is determined based on the detected two contacts. Method 1100 then proceeds to step S1140.

If, however, three contacts are detected at step S1128, then method 1100 proceeds to step S1136 where a third response is determined based on the detected three contacts. Method 1100 then proceeds to step S1140.

Alternatively, or in addition, method 1100 may determine whether the number of contacts are increasing or decreasing at step S1144 following the detection of stylus at step S1108. In some instances, a response, such as a fourth response and a fifth response may be determined based on whether the number of contacts are increasing or decreasing. For example, if the number of contacts are increasing such that two, three, or four members of stylus 116 are contacting the touchscreen 108, this may indicate that a user is adjusting a user-configurable control utilizing one or more discrete steps such that an appropriate response may be determined.

If at step S1108, a stylus is not detected, method 1100 may proceed to step S1156 where a response in accordance with finger input detection is generated. For example, if a user is using a finger as a stylus to provide input to the electronic device 104, the user may simply be navigating through the user interface. Accordingly, a response consistent with the navigation being performed by the user may be appropriate. Method 1100 then ends at step S1140.

Of course, method 1100 is not limited to detecting one, two, or three contacts between a stylus member and touchscreen. Method 1100 may detect more or less contacts depending on the configuration of the stylus. Further, each response may depend on an identification of the stylus, as previously discussed with respect to FIG. 10.

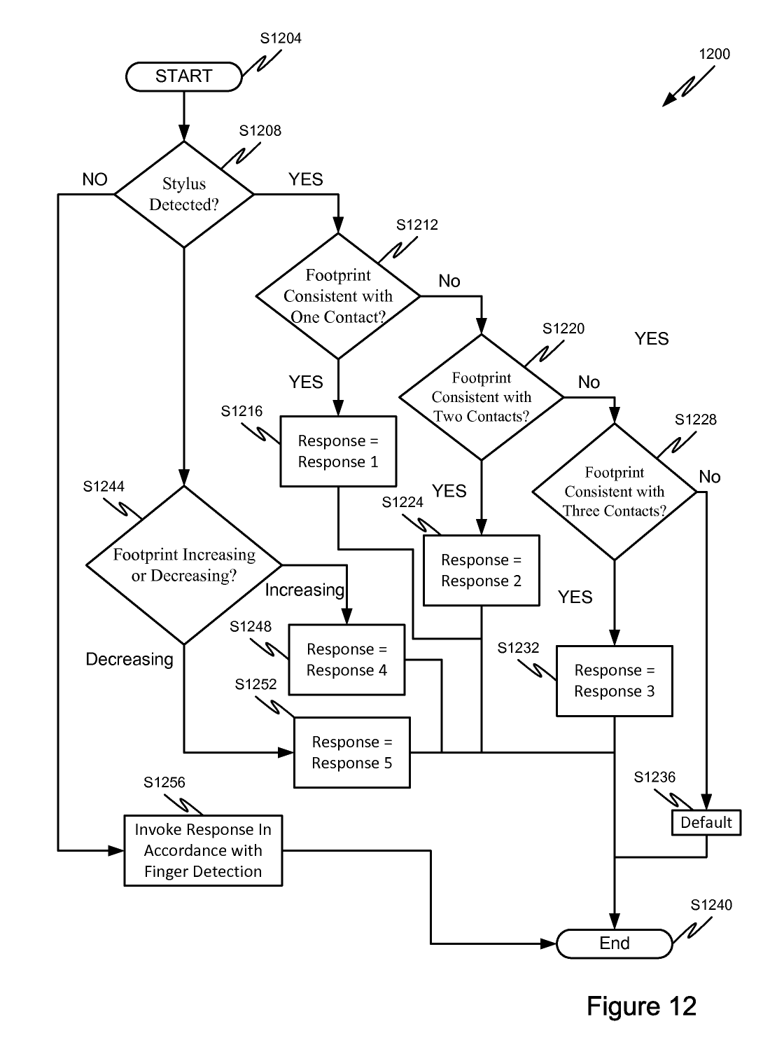

Referring now to FIG. 12, a method 1200 of detecting an input and determining a response will be discussed in accordance with embodiments of the present disclosure. Method 1200 is in embodiments, performed by a device, such as an electronic device 104, and/or more specifically, the contact detector 932. More specifically, one or more hardware and software components may be involved in performing method 1200. In one embodiment, one or more of the previously described devices perform one or more of the steps of method 1200. The method 1200 may be executed as a set of computer-executable instructions executed by an electronic device 104 and encoded or stored on a computer-readable medium. Hereinafter, the method 1200 shall be explained with reference to systems, components, modules, software, etc. described with FIGS. 1-11.

Method 1200 may continuously flow in a loop, flow according to a timed event, or flow according to a change in an operating or status parameter. Method 1200 is initiated at step S1204 where, for example, method 1000 may have detected an input at step S1008. Method 1200 then proceeds to step S1208 where method 1200 determines whether a stylus has been detected. If a stylus has been detected at step S1208, method 1200 may proceed step S1212 where method 1200 determines whether a footprint consistent with one contact has been detected, wherein a contact is contact between a stylus 116 and/or finger 804 and the touchscreen 108. For example, a first member of a stylus may make an initial contact with a touchscreen 108, wherein the initial contact has a footprint. The contact detector 932 may then compare the detected input, e.g. the footprint, to one or more footprints corresponding to the first member of the stylus 116 and stored in the footprint store 936. Upon determining that the detected input may match or otherwise be consistent with a stored footprint corresponding to a first member, a first response may be determined at step S1216. If the detected input is not consistent with a footprint corresponding to a first member, then method 1200 proceeds to step S1220 to determine whether the input is consistent with a footprint having two contacts.

At step S1220, method 1200 determines whether a footprint consistent with two contacts has been detected, wherein a contact is contact between a stylus 116 and the touchscreen 108. For example, a first member and a second member of a stylus may make an initial contact with a touchscreen 108, wherein the contact of the two members produces a footprint. The contact detector 932 may then compare the detected input, e.g. the footprint, to one or more footprints corresponding to the second member of the stylus 116 and stored in the footprint store 936. Upon determining that the detected input may match or otherwise be consistent with a stored footprint corresponding to a second member, a second response may be determined at step S1224. If the detected input is not consistent with a footprint corresponding to a first member, then method 1200 proceeds to step S1228 to determine whether the input is consistent with a footprint having three contacts.

At step S1228, method 1200 determines whether a footprint consistent with three contacts has been detected, wherein a contact is a contact between a stylus 116 and the touchscreen 108. For example, a first member, a second member, and a third member of a stylus may make an initial contact with a touchscreen 108, wherein the contact has a footprint. The contact detector 932 may then compare the detected input, e.g. the footprint, to one or more footprints corresponding to the second member of the stylus 116 and stored in the footprint store 936. Upon determining that the detected input may match or otherwise be consistent with a stored footprint corresponding to a third member, a third response may be determined at step S1232. If the detected input is not consistent with a footprint corresponding to a third member, then method 1200 proceeds to step S1236 where a default action consistent with an input not having a footprint that matches any of the stored footprints is executed. The method 1200 then ends at step S1240.

Alternatively, or in addition, method 1200 may determine whether the footprint corresponding to the detected input is increasing or decreasing at step S1244 following the detection of stylus at step S1208. In some instances, a response, such as a fourth response and a fifth response may be determined based on whether the footprint corresponding to the detected input is increasing or decreasing. For example, a footprint corresponding to the detected input increasing from a previously detected footprint may indicate that a user is adjusting a user-configurable control utilizing one or more discrete steps such that an appropriate response is determined.

If at step S1208, a stylus is not detected, method 1200 may proceed to step S1256 where a response in accordance with finger input detection is generated. For example, if a user is using a finger as a stylus to provide input to the electronic device 104, the user may simply be navigating through the user interface. Accordingly, a response consistent with the navigation being performed by the user may be appropriate. Method 1200 then ends at step S1240.

Of course, method 1200 is not limited to detecting footprints corresponding to one, two, or three contacts between a stylus member and touchscreen. Method 1200 may detect more or less contacts depending on the configuration of the stylus. Further, each response may depend on an identification of the stylus, as previously discussed with respect to FIG. 10.

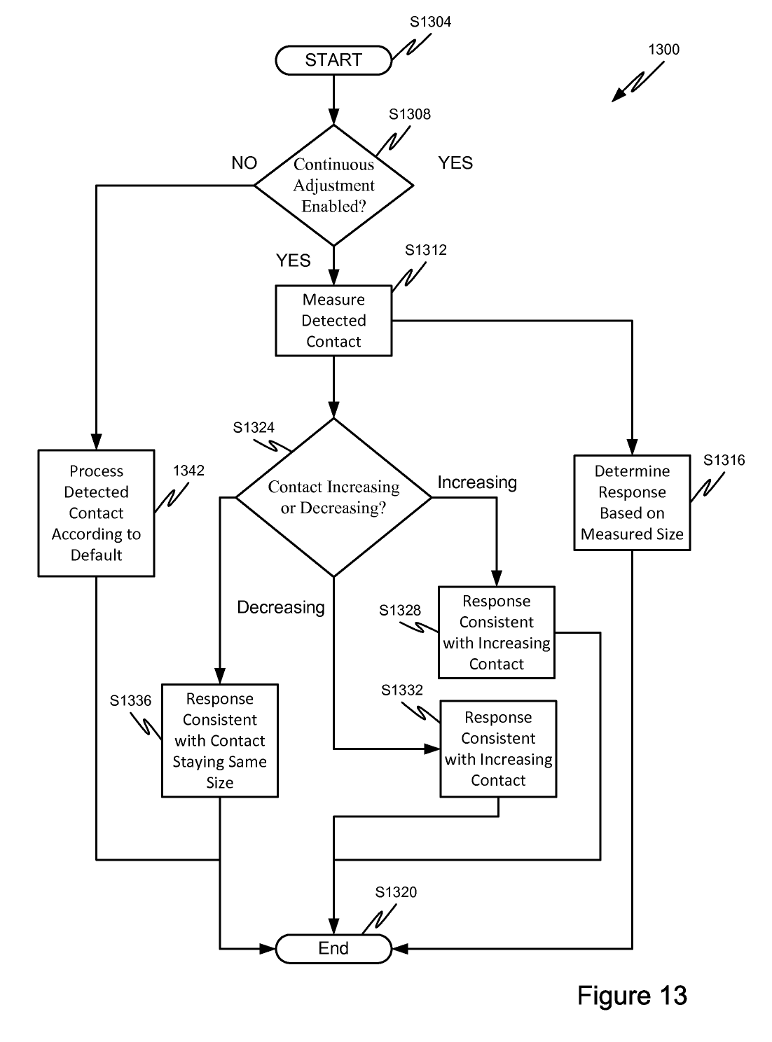

Referring now to FIG. 13, a method 1300 of detecting an input and determining a response will be discussed in accordance with embodiments of the present disclosure. Method 1300 is in embodiments, performed by a device, such as an electronic device 104, and/or more specifically, the contact detector 932. More specifically, one or more hardware and software components may be involved in performing method 1300. In one embodiment, one or more of the previously described devices perform one or more of the steps of method 1300. The method 1300 may be executed as a set of computer-executable instructions executed by an electronic device 104 and encoded or stored on a computer-readable medium. Hereinafter, the method 1300 shall be explained with reference to systems, components, modules, software, etc. described with FIGS. 1-12.

Method 1300 may continuously flow in a loop, flow according to a timed event, or flow according to a change in an operating or status parameter. Method 1300 is initiated at step S1304 where, for example, method 1000 may have detected an input at step S1008. Method 1300 then proceeds to step S1308 where method 1300 determines whether a continuous adjustment mode has been enabled. For example, electronic device 104, when used with a stylus that deforms in a consistent manner, provides continuous variation adjustment responses as opposed to one or more discrete steps or discrete responses. For instance, as pressure is applied to a stylus, such as stylus 116 or a finger 804, the stylus and/or the finger deform in a smooth, predictable way depending on the pressure applied. In some instances, continuous adjustment may be enabled specifically by the user. In other instances, continuous adjustment may be enabled according to a specific function or operation to be invoked. For example, a user may be adjusting a brightness of a display; the operation or function responsible for adjusting the brightness of a display may be configured to detect a continuous change in the footprint of a stylus, and in response to this change increase or decrease the brightness. Accordingly, if the continuous adjustment mode has been enabled, method 1300 proceeds to step S1312 where the contact detector 932 may measure the size of a footprint or contact corresponding to the input at touchscreen 108.

Based on the measured size of the footprint, a response is determined at step S1316. For example, as a portion of a finger 804 or stylus tip 604, 704 contacts the touchscreen 108, the contact may be detected as a footprint having one or more of a width, height, diameter, radius, or similar measurable attribute. A response proportional to a maximum and minimum sized footprint may then be determined. As one example, a maximum diameter footprint may be 2.5 cm, while a minimum diameter footprint may be 0.5 cm. Therefore, if a portion of a finger 804, or stylus tip 607, 704 contacts the touchscreen with a detectable footprint having a measured diameter equal to 2.0 cm, a response corresponding to seventy-five percent of a maximum response may be determined. For instance, if 2.5 cm or one-hundred percent represented a brightness of an electronic device 104 of one-hundred percent, and 0.5 cm or zero percent represented a brightness of an electronic device 104 of zero percent, then a determined response may corresponding to a seventy-five percent brightness. Of course, this illustration simply represents a one-to-one correspondence between the detected footprint size and the determined response. In some embodiments, more elaborate algorithms may be utilized when determining an appropriate response. After determining a response at S1316, method 1300 proceeds to step S1320.

Alternatively, or in addition, method 1300 may determine whether the footprint corresponding to the detected input is increasing, decreasing, or staying the same at step S1324. In some instances, a response may be determined based on whether the footprint corresponding to the detected input is increasing, decreasing, or staying the same. For example, if the footprint corresponding to the detected input increases from a previously detected footprint, this may indicate that a user is adjusting a user-configurable control and because the continuous adjustment has been enabled, an appropriate response may include a response consistent with an increasing contact, such as at step S1328. Or the response may include a response that is consistent with a decreasing contact, such as at step S1332. Alternatively, or in addition, if the detectable footprint's size is neither increasing or decreasing, but instead staying the same, an appropriate response may take this into account, such as at step S1236. For instance, if a previous response indicated the brightness level should be at 75%, if the detected footprint is smaller than a previously detected footprint, an appropriate response may include subtracting one or two brightness percentages from the current brightness level and/or increasing a rate at which the brightness level decreases. On the other hand, if the detected footprint is larger than a previously detected footprint, an appropriate response may include adding one or two brightness percentages from to the current brightness level and/or increasing the rate at which the brightness level increases. Instead, if the detected footprint is the same size as the previously detected footprint, an appropriate response may include not adjusting a brightness level; or, the response may be to continue a previous response but at the same rate.

If at step S1308, continuous adjustment is not enabled, then method 1300 proceeds to step S1342 where the detected contact is processed in accordance with a default processing technique. Method 1300 then ends at step S1320.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method comprising:
detecting, at an input receiving device associated with an electronic device, an input;
determining whether the detected input corresponds to one or more stored footprints of a stylus;
determining at least one response associated with the corresponding one or more stored footprints of the stylus, wherein the stylus is capable of creating a plurality of discrete footprints depending on a pressure applied to the stylus; and
invoking the at least one response at the device.

2. The method of claim 1, further comprising:
determining whether to invoke a first operational mode or a second operational mode based on an identification of the stylus, wherein the at least one response is based on the determined operational mode.

3. The method of claim 2, further comprising:
determining a first response based on a first stored footprint;
determining a second response based on a second footprint;
wherein the first stored footprint corresponds to a detection of an input corresponding to a first member of the stylus and wherein the second stored footprint corresponds to a detection of an input corresponding to the first member and a second member of the stylus.

4. The method of claim 3, further comprising:
determining a third response based on a third stored footprint, wherein the third stored footprint corresponds to a detection of an input corresponding to the first member, the second member, and a third member of the stylus.

5. The method of claim 3, further comprising:
determining a fourth response when no input is detected.

6. The method of claim 1, further comprising:
invoking a first operational mode when the detected input corresponds to that of a stylus; and
invoking a second operational mode when the detected input corresponds to that of a finger.

7. The method of claim 1, further comprising:
determining a first response based on a first detected footprint;
determining a second response based on a second detected footprint;
wherein the first detected footprint and the second detected footprint are different.

8. The method of claim 1, wherein the input receiving device is a touch screen.

9. A non-transitory computer-readable medium, having instructions stored thereon, that when executed cause the steps of claim 1 to be performed.

10. A method comprising:
detecting, at a touchscreen associated with an electronic device, contact between a stylus tip and the touchscreen, wherein the stylus tip deforms in a continuous manner depending on a pressure applied to the stylus;
measuring at least one attribute of the detected contact;
determining a response based on the measurement of the at least one attribute of the detected contact; and
invoking the response at the device.

11. The method of claim 10, wherein the response is associated with an operation that supports user-controlled continuous variation.

12. The method of claim 11, further comprising:
measuring the at least one attribute of the detected contact to obtain a second measurement;
varying the response based upon the second measurement; and
invoking the varied response based upon the second measurement.

13. The method of claim 10, wherein the attribute is at least one of size, length, width, area, and circumference of a detected contact.

14. The method of claim 10, further comprising:
determining whether to invoke a first operational mode or a second operational mode based on an identification of the stylus tip.

15. An electronic device comprising:
an input receiving device;
a contact detector that detects contact between a stylus and the input receiving device, the contact detector configured to determine whether the detected contact corresponds to one or more stored footprints of the stylus; and
a controller that determines at least one response associated with the corresponding one or more stored footprints of the stylus and invokes the at least one response.

16. The input receiving device of claim 15, wherein the controller is further configured to:
determine a first response based upon a first stored footprint; and
determine a second response based upon a second footprint;
wherein the first stored footprint corresponds to a detection of contact between a first member of the stylus and the input receiving device, and wherein the second stored footprint corresponds to (i) a detection of contact between a first member of the stylus and the input receiving device; and (ii) a detection of contact between a second member of the stylus and the input receiving device.

17. The input receiving device of claim 15, wherein the controller is further configured to:
determine whether to invoke a first operational mode or a second operational mode based on an identification of the stylus, wherein the at least one response is based on the determined operational mode.

18. The input receiving device of claim 15, wherein the controller is further configured to determine a third response based upon a third stored footprint, wherein the third stored footprint corresponds to (i) a detection of contact between a first member of the stylus and the input receiving device; (ii) a detection of contact between the second member of the stylus and the input receiving device; and (iii) a detection of contact between a third member of the stylus and the input receiving device.

19. The input receiving device of claim 15, wherein the controller is further configured to:
determine a fourth response when one or more of the first member of the stylus and the second member of the stylus is no longer in contact with the input receiving device.

20. The input receiving device of claim 15, wherein the input receiving device is a touch screen of an electronic device.
